(19) United States
(12) Patent Application Publication
(10) Pub. No.: US 2006/0157262 A1
(43) Pub. Date: Jul. 20, 2006

(54) Power tool having presetable digital control of torque output

(76) Inventor: Jui-Yu Chen, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/035,354

(22) Filed: Jan. 14, 2005

(51) Int. Cl. B23Q 5/00

(52) U.S. Cl. 173/176; 173/2; 173/217

(57) ABSTRACT

A power tool includes a main frame, a motor, and an electronic control device. The electronic control device that can detect the torque output of the power tool, so that when the output state of the main frame reaches the preset torque output of the power tool, the electronic control device interrupts the electric power to the motor so that the motor stops operating immediately.

### BACKGROUND OF THE INVENTION

1. Field of the Invention

The present invention relates to a power tool, such as a motorized wrench, and more particularly to a power tool having a presetable digital control of torque output.

b 2. Description of the Related Art

A conventional motorized wrench in accordance with the prior art shown in FIG. 5 is used to mount and detach screws of attire and comprises a housing 1, a motor 11 mounted in the housing 1 and having an end provided with a drive gear 111, a main frame 12 mounted in the housing 1 and having a first side provided with a driven gear 121 meshing with and rotated by the drive gear 111 of the motor 11, an output shaft 13 mounted in the housing 1 and having a first end secured to a second side of the main frame 12 and a second end protruding from the housing 1 and formed with a mounting portion 131, a clutch device 14 mounted in the main frame 12, and a switch 15 mounted in the housing 1 to control operation of the motor 11.

However, the user cannot judge the exact torque output of the power tool, so that when the output torque of power tool motor is too large, the screw of the tire is easily worn out or broken by the high power rotation of the output shaft 13, and when the output torque of the power tool is too small, the screw of the tire is easily loosened.

The closest prior art references of which the applicant is aware are disclosed in his U.S. Pat. No. 5,887,666; 6,119,794 and 6,283,226.

### SUMMARY OF THE INVENTION

In accordance with the present invention, there is provided a power tool, comprising: a main frame; a motor providing a power to the main frame; and an electronic control device connected to the motor; wherein the electronic control device can input and preset a predetermined torque output; the electronic control device can detect an output state of the main frame; when the output state of the main frame reaches the predetermined torque output, the electronic control device interrupts the electric power to the motor automatically, so that the motor stops operating immediately.

The primary objective of the present invention is to provide a power tool having a presetable digital control of torque output.

Another objective of the present invention is to provide a power tool, wherein the torque output of the power tool can be preset by the user, so that when the output state of the main frame reaches the preset torque output of the power tool, the motor stops operating immediately.

A further objective of the present invention is to provide a power tool provided with an electronic control device that can detect the torque output of the power tool, so that when the output state of the main frame reaches the preset torque output of the power tool, the electronic control device interrupts the electric power to the motor so that the motor stops operating immediately.

Further benefits and advantages of the present invention will become apparent after a careful reading of the detailed description with appropriate reference to the accompanying drawings.

### BRIEF DESCRIPTION OF THE DRAWINGS

FIG. 1 is a plan cross-sectional view of a power tool in accordance with the preferred embodiment of the present invention;

FIG. 2 is a plan view of a panel of the power tool as shown in FIG. 1;

FIG. 3 is a block diagram of the power tool as shown in FIG. 1;

FIG. 4 is a circuit layout of the power tool as shown in FIG. 1; and

FIG. 5 is a plan cross-sectional view of a conventional power tool in accordance with the prior art.

### DETAILED DESCRIPTION OF THE INVENTION

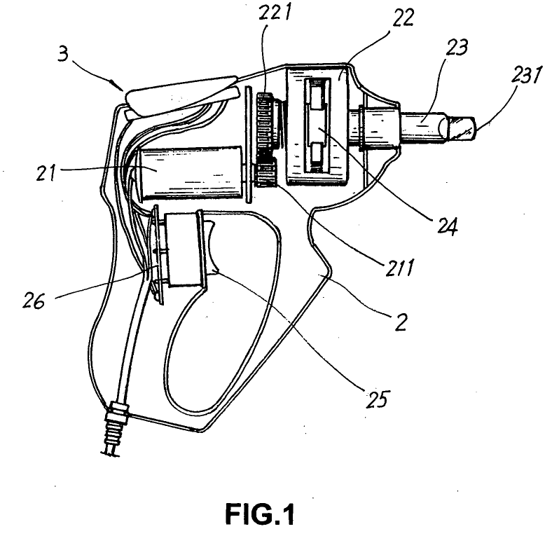

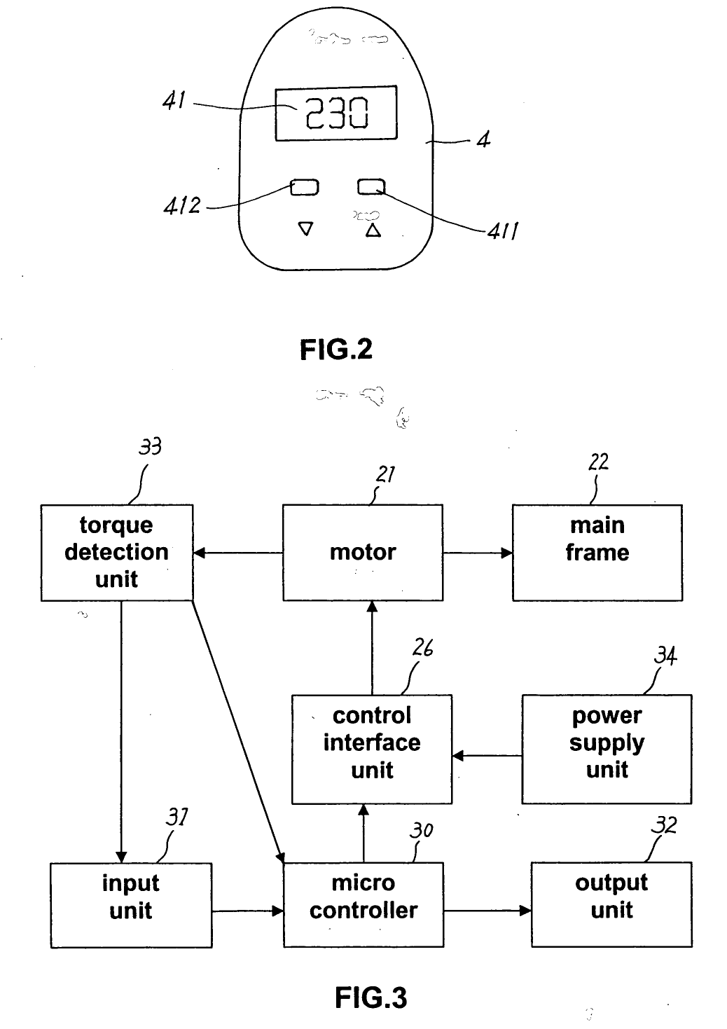

Referring to the drawings and initially to FIGS. 1-3, a power tool, such as a motorized wrench, in accordance with the preferred embodiment of the present invention comprises a housing 2, a motor 21 mounted in the housing 2 and having an end provided with a drive gear 211, a main frame 22 mounted in the housing 2 and having a first side provided with a driven gear 221 meshing with and rotated by the drive gear 211 of the motor 21, an output shaft 23 mounted in the housing 2 and having a first end secured to a second side of the main frame 22 and a second end protruding from the housing 2 and formed with a mounting portion 231, a clutch device 24 mounted in the main frame 22, a switch 25 mounted in the housing 2 to control operation of the motor 21, and an electronic control device 3 mounted on an upper portion of the housing 2 and located above the motor 21. The main frame 22 is an impact mechanism. Preferably, the electronic control device is all available for a pneumatic power tool, a motorized power tool, a motorized screwdriver and a motorized drill-etc.

The electronic control device 3 includes a micro controller 30, a control interface unit 26 connected to the micro controller 30 and connected to the motor 21 by the switch 25, a power supply unit 34 connected to the control interface unit 26, an input unit 31 connected to the micro controller 30, a torque detection unit 33 connected to the micro controller 30 and connected to the input unit 31, and an output unit 32 connected to the micro controller 30. In addition, the motor 21 is connected to the main frame 22.

The power supply unit 34 is connected to the control interface unit 26 to supply an electric power to the motor 21 and the micro controller 30.

The input unit 31 is used to input preset torque values by a user and includes a first push button 411 and a second push button 412 mounted on a panel 4 respectively to adjust the preset torque values.

The output unit 32 is used to output the present torque values and includes an LED indicator 41 mounted on the panel 4.

The torque detection unit 33 is used to detect the output state (the torque output value) of the main frame 22 to obtain a feedback signal which is transmitted into the micro controller 30 which performs an operation process so as to control the control interface unit 26.

The control interface unit 26 is an interface of the micro controller 30 and controlled by the micro controller 30 to drive the motor 21.

The micro controller 30 is the control center of the electronic control device 3 and is used to performs an operation process on the feedback signal from the torque detection unit 33.

The motor 21 has a larger load and is driven by the control interface unit 26 to provide a power to the main frame 22. The clutch device 24 of the main frame 22 is used to convert the successive output force of the motor 21 into an intermittent impact force.

In operation, after the electric power of the power supply unit 34 is connected, the user inputs the preset torque value by the first push button 411 and the second push button 412 of the input unit 31. Then, the switch 25 is started to drive the motor 21 to operate. At this time, the torque detection unit 33 transmits the detected feedback signal of the torque output value into the micro controller 30 which performs an operation process on the detected feedback signal of the torque output value of the torque detection unit 33. Then, the micro controller 30 transmits an output signal to the control interface unit 26 to drive the motor 21. At the same time, the micro controller 30 transmits an output signal to the output unit 32 to indicate the present torque value on the indicator 41, so that the user can inspect the present torque value of the power tool. In addition, when the torque value of the power tool reaches the preset torque value, the micro controller 30 transmits a signal to the control interface unit 26 to stop operation of the motor 21.

Accordingly, the torque output of the power tool can be preset by the user, so that when the output state of the main frame 22 reaches the preset torque output of the power tool, the motor 21 stops operating immediately. In addition, the power tool is provided with an electronic control device 3 that can detect the torque output of the power tool, so that when the output state of the main frame 22 reaches the preset torque output of the power tool, the electronic control device 3 interrupts the electric power to the motor 21 so that the motor 21 stops operating immediately.

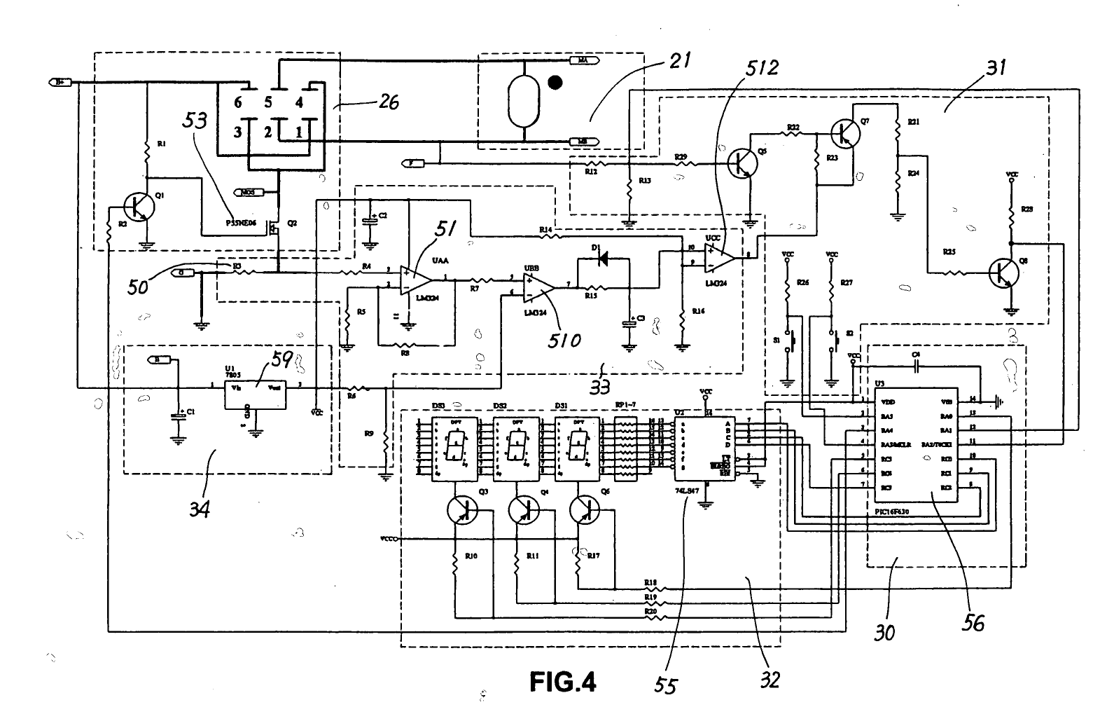

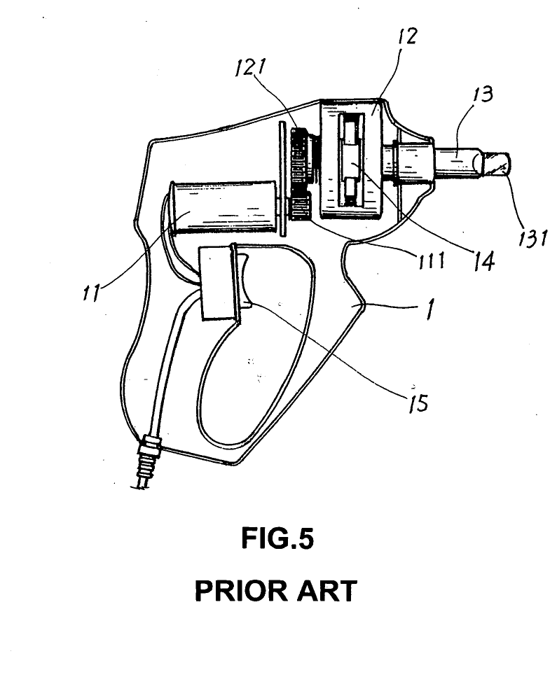

Referring to FIG. 4, the circuit of the electronic control device 3 is described as follows. First of all, the resistor (R3) numbered by 50 obtains the current signal which is sent into a first LM324 numbered by 51 to amplify the current signal. Then, the amplified current signal passes through a second LM324 numbered by 510 to rectify the current signal. Then, the rectified current signal passes through a third LM324 numbered by 512 to perform a TTL level output. Then, the output current passes through the input unit 31 into the micro controller 30. The control interface unit 26 functions as an interface of the micro controller 30 and controlled by the micro controller 30 to drive the motor 21 having a larger load. The control interface unit 26 has a MOSFET, such as the control circuit composed of the P55NE06 numbered by 53. The input unit 31 is used to input preset torque values by a user to facilitate the user adjusting the preset torque values. The output unit 32 includes a decoding IC, such as SN74LS47 numbered by 55, to decode the information codes from the micro controller 30 into the indication codes required by the LED indicator 41 so as to indicate the preset torque values and the present torque values. The micro controller 30, such as Microchip PIC16F630 numbered by 56, is the control center of the electronic control device 3 of the power tool. The micro controller 30 embeds a kernel program into the FLASH memory so as to control the power tool exactly. The power supply unit 34, such as 7805 numbered by 59, supplies an electric power of DC12V to the motor 21 and an electric power of DC5V to the micro controller 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A power tool, comprising:
a main frame;
a motor providing a power to the main frame;
an electronic control device connected to the motor; wherein
the electronic control device can input and preset a predetermined torque output;
the electronic control device can detect an output state of the main frame;
when the output state of the main frame reaches the predetermined torque output, the electronic control device interrupts an electric power to the motor automatically, so that the motor stops operating immediately.

2. The power tool in accordance with claim 1, wherein the electronic control device includes:
a micro controller;
a control interface unit connected to the micro controller and connected to the motor;
an input unit connected to the micro controller;
a torque detection unit connected to the micro controller and connected to the input unit; and
an output unit connected to the micro controller.

3. The power tool in accordance with claim 2, wherein the control interface unit is connected to the motor by a switch.

4. The power tool in accordance with claim 2, wherein the electronic control device further includes a power supply unit connected to the control interface unit to supply an electric power to the motor and the micro controller.

5. The power tool in accordance with claim 2, wherein the input unit is used to input the predetermined torque output by a user and includes a first push button and a second push button mounted on a panel respectively to adjust the predetermined torque output.

6. The power tool in accordance with claim 2, wherein the output unit includes an indicator mounted on a panel.

7. The power tool in accordance with claim 2, wherein the control interface unit is an interface of the micro controller and controlled by the micro controller to drive the motor.

8. The power tool in accordance with claim 2, wherein the micro controller is a control center of the electronic control device and is used to performs an operation process on a feedback signal from the torque detection unit.

9. The power tool in accordance with claim 2, wherein the motor is driven by the control interface unit to provide a power to the main frame.

10. The power tool in accordance with claim 1, wherein the electronic control device is available for a pneumatic power tool.

11. The power tool in accordance with claim 1, wherein the electronic control device is available for a motorized power tool.

12. The power tool in accordance with claim 1, wherein the electronic control device is available for a motorized screwdriver.

13. The power tool in accordance with claim 1, wherein the electronic control device is available for a motorized drill.
